(19) United States
(12) Patent Application Publication
(10) Pub. No.: US 2016/0249389 A1
(43) Pub. Date: Aug. 25, 2016

(54) MOBILE COMMUNICATION SYSTEM

(71) Applicant: NTT DOCOMO, INC., Tokyo (JP)

(72) Inventors: Hideaki Takahashi, Tokyo (JP); Wuri Andarmawanti Hapsari, Tokyo (JP); Tooru Uchino, Tokyo (JP)

(73) Assignee: NTT DOCOMO, INC., Tokyo (JP)

(21) Appl. No.: 15/024,794

(22) PCT Filed: Sep. 25, 2014
(86) PCT No.: PCT/JP2014/075468

§ 371 Date: Mar. 24, 2016

(30) Foreign Application Priority Data
Sep. 26, 2013 (JP) 2013-200657

(51) Int. Cl. H04W 76/02; H04W 72/04

(52) U.S. Cl. CPC H04W 76/02; H04W 72/0453; H04W 84/20

(57) ABSTRACT

An object of the present invention is to appropriately set an SRB0 to an SRB2 when “Inter-eNB CA” is performed. In a mobile communication system of the present invention, the SRB0, the SRB1, and the SRB2 are configured to be established between a mobile station UE and a radio base station MeNB when the “Inter-eNB CA” is performed, and a radio base station SeNB is configured to send the mobile station UE “SRB-ToAddMod” when the radio base station SeNB is added, to establish an SRB1 and an SRB2 between the mobile station UE and the radio base station SeNB with the same setting contents as those of the SRB1 and the SRB2 established between the mobile station UE and the radio base station MeNB.

### TECHNICAL FIELD

The present invention relates to a mobile communication system.

### BACKGROUND ART

In CA (Carrier Aggregation) specified up to LIE (Long Term Evolution) Release-10, high throughput can be achieved by performing simultaneous communication using a CC (Component Carrier) #1 and a CC#2 under the same radio base station eNB as illustrated in part (a) of FIG. 6.

Meanwhile, “Inter-eNB CA (or Inter-node UP aggregation) ” is considered in LIE Release-12. In the “Inter-eNB CA,” the CA up to LTE release-10 is expanded and high throughput is achieved by performing simultaneous communication using a CC#1 and a CC#2 under different radio base stations eNB#1 and eNB#2 as illustrated in part (b) of FIG. 6 (see Non-patent document 1).

For example, when all CCs cannot be housed in a single radio base station eNB, the “Inter-eNB CA” needs to be performed to achieve throughput comparable to that in LIE Release-10.

### PRIOR ART DOCUMENT

### Non-Patent Document

Non-patent document 1: 3GPP TDoc (written contribution) R2-131782

### SUMMARY OF THE INVENTION

However, the existing LTE method has a problem that there is no specification on how to establish SRBs (Signaling Radio Bearers) when the “Inter-eNB CA” described above is performed.

The present invention has been made in view of the problem described above, and an object thereof is to provide a mobile communication system capable of appropriately setting an SRB0 to an SRB2 when “Inter-eNB CA” is performed.

A first feature of the present invention is summarized as a mobile communication system configured such that a mobile station is capable of performing carrier aggregation using a cell under a master radio base station and a cell under a slave radio base station. Here, an SRB0, an SRB1, and an SRB2 are configured to be established between the mobile station and the master radio base station when the carrier aggregation is performed, and the slave radio base station is configured to send the mobile station a signal for adding or changing SRBs when the slave radio base station is added, to establish an SRB1 and an SRB2 between the mobile station and the slave radio base station with the same setting contents as those of the SRB1 and the SRB2 established between the mobile station and the master radio base station.

A second feature of the present invention is summarized as a mobile communication system configured such that a mobile station is capable of performing carrier aggregation using a cell under a master radio base station and a cell under a slave radio base station. Here, an SRB0, an SRB1, and an SRB2 are configured to be established between the mobile station and the master radio base station when the carrier aggregation is performed, the master radio base station is configured to notify the slave radio base station of setting information of the SRB1 and the SRB2 and give an instruction to the mobile station to add the slave radio base station, and the mobile station is configured to use the setting information of the SRB1 and the SRB2 established between the mobile station and the master radio base station to apply to setting for sending a signal on the SRB1 and the SRB2 via the slave radio base station, in response to the instruction.

### BRIEF DESCRIPTION OF THE DRAWINGS

FIG. 1 is an overall configuration diagram of a mobile communication system in a first embodiment of the present invention.

FIG. 2 is a sequence diagram illustrating operations of the mobile communication system in the first embodiment of the present invention.

FIG. 3 is a view illustrating an example of a format of “SRB-ToAddMod” sent by a radio base station eNB#2 in the first embodiment of the present invention.

FIG. 4 is an overall. configuration diagram of a mobile communication system in a second embodiment of the present invention.

FIG. 5 is a sequence diagram illustrating operations of the mobile communication system in the second embodiment of the present invention

FIG. 6 is a view for explaining a conventional technique.

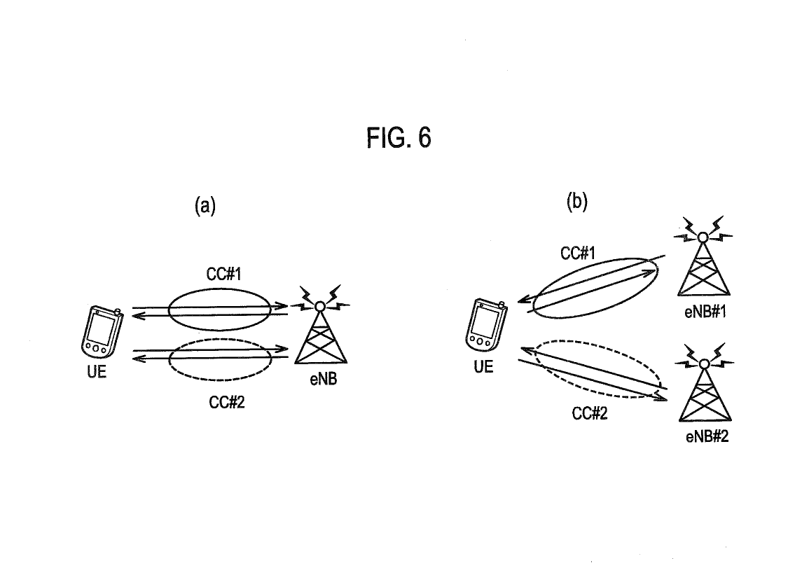

### DETAILED DESCRIPTION

### Mobile Communication System in First Embodiment of Present Invention

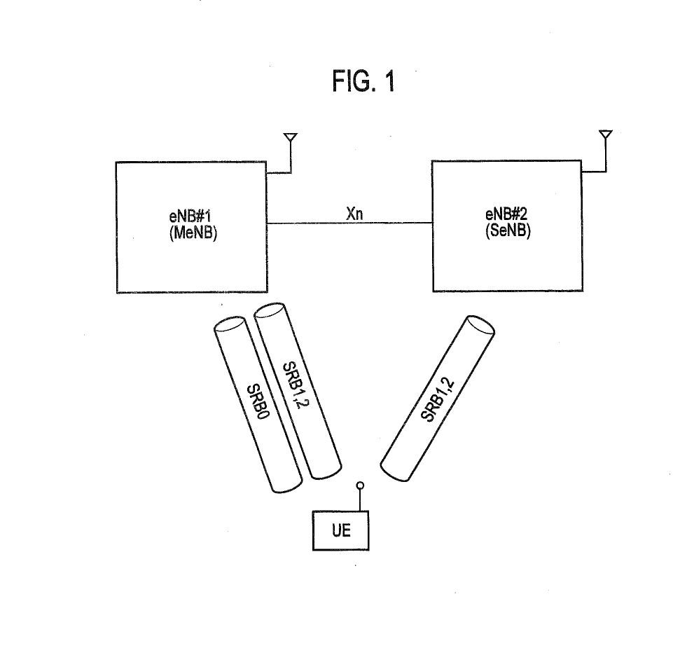

A mobile communication system in a first embodiment of the present invention will be described with reference to FIGS. 1 to 3. An LTE mobile communication system will be described as an example of the mobile communication system in the embodiment. However, the present invention can be applied to mobile communication systems other than the LTE mobile communication system.

As illustrated in FIG. 1, the mobile communication system in the embodiment includes a radio base station eNB#1 and a radio base station eNB#2.

In the mobile communication system in the embodiment, the radio base station eNB#1 is assumed to be a master radio base station (or a macro radio base station managing a macro cell) M-eNB, and the radio base station eNB#2 is assumed to be a slave radio base station (or a small radio base station managing a small cell) S-eNB.

Moreover, in the mobile communication system of the embodiment, a mobile station UE is configured to be capable of performing “Inter-eNB CA” using a cell under the radio base station eNB#1 and a cell under the radio base station eNB#2.

In order to perform such “Inter-eNB CA, ” the radio base station eNB#1 and the mobile station UE have an RRC (Radio Resource Control) layer function. The radio base station eNB#2 may not have the RRC layer function.

In such a case, the RRC layer function of the radio base station eNB#1 is configured to generate all RRC messages to the mobile station UE and send the RRC messages to the mobile station UE.

Alternatively, all of the radio base station eNB#1, the radio base station eNB#2, and the mobile station UE may have the RRC (Radio Resource Control) layer function to perform the “Inter-eNB CA” described above.

In such a case, each of the RRC layer function of the radio base station eNB#1 and the RRC layer function of the radio base station eNB#2 is configured to generate the RRC messages to the mobile station UE, and send the RRC messages to the mobile station UN.

Note that the RRC messages to be generated by the RRC layer function of the radio base station eNB#1 and the RRC messages to be generated by the RRC layer function of the radio base station eNB#2 are determined according to the specifications of LTE.

As illustrated in FIG. 1, an SRB0, an SRB1, and an SRB2 are configured to be established between the mobile station UE and the radio base station eNB#1 when the “Inter-eNB CA” described above is performed.

In this case, the SRB0 is configured to send only the basic signaling for establishment of RRC connection such as RRC connection establishment or RRC connection reestablishment, or rejection of an RRC connection request signal. Accordingly, the SRB0 is configured to be established only between the mobile station UE and the radio base station eNB#l, and not to be established between the mobile station UE and the radio base station eNB#2

Moreover, the SRB1 is a bearer for sending the RRC message together with a NAS (Non-Access Stratum) message before establishment of the SRB2

Furthermore, the SRB2 is a bearer for sending the RRC message including “logged. measurement information” together with the NAS message. The SRB2 has a lower priority than the SRB1 and is established by E-UTRAN after “security action.”

The RRC messages to be sent through the SRB1 and the SRB2 may be sent by the radio base station eNB#1 or the radio base station eNB#2.

Accordingly, the SRB1 and the SRB2 with the same setting contents as those of the SRB1 and the SRB2 established between the mobile station UE and the radio base station eNB#1 are configured to be established between the mobile station UE and the radio base station eNB#2 when the “inter-eNB CA” described above is performed.

The radio base station eNB#2 is configured to send existing “SRB-ToAddMod” to the mobile station UE when the radio base station eNB#2 is added, to establish the SRB1 and the SRB2 between the mobile station UE and the radio base station eNB#2 with the same setting contents as those of the SRB1 and the SRB2 established between the mobile station UE and the radio base station eNB#1.

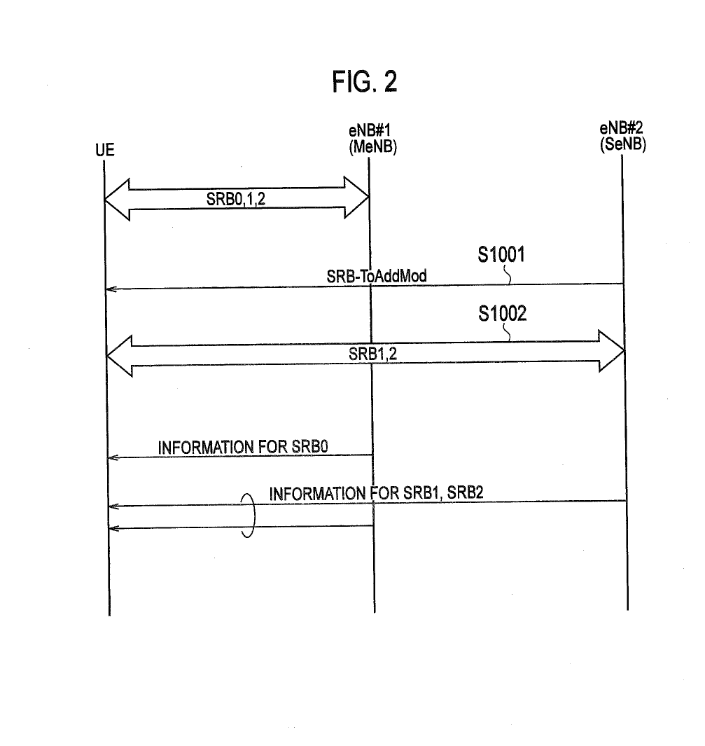

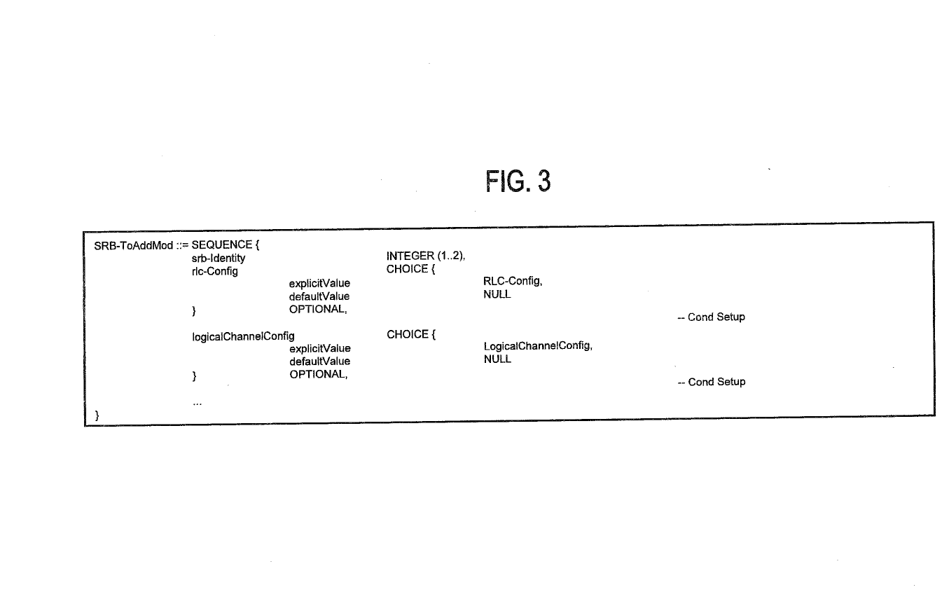

Operations of the mobile communication system in the embodiment will be described below with reference to FIGS. 2 and 3.

As illustrated in FIG. 2, when a determination is made to add the radio base station eNB#2 in a state where the SRB0, the SRB1, and the SRB2 are established between the mobile station UE and the radio base station eNB#1 (when a determination is made to cause the mobile station UE to perform the “Inter-eNB CA” using the cell under the radio base station eNB#1 and the cell under the radio base station eNB#2), the radio base station eNB#2 sends the mobile station UE the “SRB-ToAddMod” illustrated in FIG. 3 in step S1001.

The “SRB-ToAddMod” described above gives an instruction to establish the SRB1 and the SRB2 between the mobile station UE and the radio base station eNB#2 with the same setting contents as those of the SRB1 and the SRB2 established between the mobile station UE and the radio base station eNB#1.

Specifically, as illustrated in FIG. 3, the radio base station eNB#2 is configured to set identification information of the SRBs by using an information element “srb-Identity” in the “SRB-ToAddMod,” perform setting in an RLC layer by using an information element “rlc-Config” in the “SRB-ToAddMod,” and perform setting related to a logical channel by using an information element “logicalChannelConfig” in the “SRB-ToAddMod.”

In step S1002, when the SRB1 and the SRB2 are established between the mobile station UE and the radio base station eNB#2, the radio base station eNB#2 sends RRC messages to be sent through the SRB1 and the SRB2, to the mobile station UE through the established SRB1 and SRB2.

Note that an RRC message to be sent through the SRB0 is sent from the radio base station eNB#1 to the mobile station UE through the SRB0 established between the mobile station UE and the radio base station eNB#1.

In the mobile communication system of the embodiment, when the “Inter-eNB CA” described above is performed, the setting contents of the SRB1 and the SRB2 established between the mobile station UE and the radio base station eNB#2 are the same as those of the SRB1 and the SRB2 established between the mobile station UE and the radio base station eNB#1. Accordingly, the mobile communication system has an effect of making the mobile station UE recognize the established SRBs1 and SRBs2 to be one SRB1 and one SRB2 as in the existing LTE method, and the mobile station UE does not have to determine from which one of the radio base stations eNB to receive the RRC messages through the SRB1 and the SRB2 established therewith.

### Mobile Communication System in Second Embodiment of Present Invention

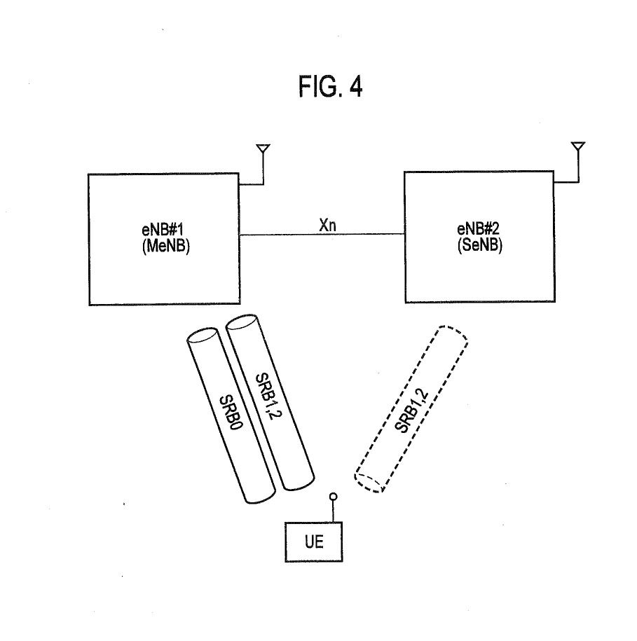

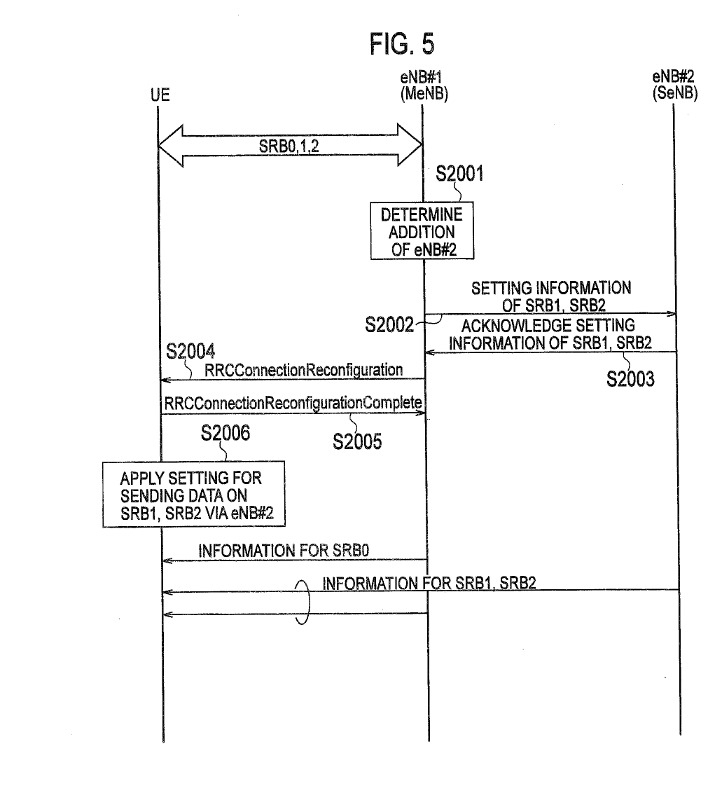

A mobile communication system in a second embodiment of the present invention will be described below with reference to FIGS. 4 and 5, while focusing on points different from the aforementioned mobile communication system in the first embodiment.

As illustrated in FIG. 4, an SRB0, an SRB1, and an SRB2 are configured to be established between a mobile station UE and a radio base station eNB#1 when the “Inter-eNB CA” described above is performed.

Meanwhile, the SRB1 and the SRB2 are configured to be established between the mobile station UE and a radio base station eNB#2 when the “Inter-eNB CA” described above is performed.

In such a case, the radio base station eNB#2 is configured to send the mobile station UE a signal to be sent on the SRB1 and the SRB2 established between the mobile station UE and the radio base station eNB#1, by using setting information of these SRB1 and SRB2.

The radio base station eNB#2 is configured to acquire the setting information of these SRB1 and SRB2 through an X2 interface between the radio base station eNB#2 and the radio base station eNB#1.

Operations of the mobile communication system in the embodiment will be described below with reference to FIG. 5.

As illustrated in FIG. 5, when the radio base station eNB#1 determines to add the radio base station eNB#2 (determines to cause the mobile station UE to perform the “Inter-eNB CA” using a cell under the radio base station eNB#1 and a cell under the radio base station eNB#2) in step S2001 in the state where the SRB0, the SRB1, and the SRB2 are established between the mobile station UE and the radio base station eNB#1, the radio base station eNB#1 sends the radio base station eNB#2 the setting information of the SRB1 and the SRB2 established between the mobile station UE and the radio base station eNB#1 in step S2002,

The radio base station eNB#2 receives the sent setting information in step S2002, and then notifies the radio base station eNB#1 that the setting is acknowledged in step S2003.

Thereafter, the radio base station eNB#1 sends “RRCConnectionReconfiguration” to the mobile station UE and instructs the mobile station UE to add the radio base station eNB#2 in step S2004.

The mobile station UE sends “RRCConnectionReconfigurationComplete” to the radio base station eNB#1 in step S2005, and uses the setting information of the SRB1 and the SRB2 established between the mobile station UE and the radio base station eNB#1 to apply to setting for sending data on the SRB1 and the SRB2 via the radio base station eNB#2 in step S2006.

Note that an RRC message to be sent through the SRB0 is sent from the radio base station eNB#1 to the mobile station UE through the SRB0 established between the mobile station UE and the radio base station eNB#1.

The mobile communication system of the embodiment is configured such that, when the “Inter-eNB CA” described above is performed, the radio base station eNB#2 sends the RRC messages to be sent through the SRB1 and the SRB2, without establishing the SRB1 and the SRB2 between the mobile station UE and the radio base station eNB#2, by using the setting information of the SRB1 and the SRB2 established between the mobile station UE and the radio base station eNB#1. Accordingly, the mobile communication system has an effect of making the mobile station UE recognize the established SRBs1 and SRBs2 to be one SRB1 and one SRB2 as in the existing LTE method, and the mobile station UE does not have to determine from which one of the radio base stations eNB to receive the RRC messages through the SRB1 and the SRB2 established therewith.

The features of the embodiment may also be expressed as follows.

A first feature of the embodiment is summarized a mobile communication system configured such that a mobile station UE is capable of performing “Inter-eNB CA (carrier aggregation)” using a cell under a radio base station MeNB (master radio base station) and a cell under a radio base station SeNB (slave radio base station). Here, an SRB0, an SRB1, and an SRB2 are configured to be established between the mobile station UE and the radio base station MeNB when the “Inter-eNB CA” is performed, and the radio base station SeNB is configured to send the mobile station UE “SRB-ToAddMod (signal for adding or changing SRBs) ” when the radio base station SeNB is added, to establish an SRB1 and an SRB2 between the mobile station UE and the radio base station SeNB with the same setting contents as those of the SRB1 and the SRB2 established between the mobile station UE and the radio base station MeNB.

A second feature of the embodiment is summarized a mobile communication system configured such that a mobile station UE is capable of performing “Inter-eNB CA” using a cell under a radio base station MeNB and a cell under a radio base station SeNB. Here, an SRB0, an SRB1, and an SRB2 are configured to be established between the mobile station UE and the radio base station MeNB when the “Inter-eNB CA” is performed, the radio base station MeNB is configured to notify the radio base station SeNB of setting information of the SRB1 and the SRB2 and give an instruction to the mobile station UE to add the radio base station SeNB, and the mobile station UE is configured to use the setting information of the SRB1 and the SRB2 established between the mobile station UE and the radio base station MeNB to apply to setting for sending an RRC message (signal) on the SRB1 and the SRB2 via the radio base station SeNB, in response to the instruction.

It should be noted that the foregoing operations of the radio base station MeNB/SeNB and the mobile station UE may be implemented by hardware, may be implemented by a software module executed by a processor, or may be implemented in combination of the two.

The software module may be provided in a storage medium in any format, such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to a processor so that the processor can read and write information from and to the storage medium. Instead, the storage medium may be integrated in a processor. The storage medium and the processor may be provided inside an ASIC. Such an ASIC may be provided in the radio base station MeNB/SeNB and the mobile station UE. Otherwise, the storage medium and the processor may be provided as discrete components inside the radio base station MeNB/SeNB and the mobile station UE.

Hereinabove, the present invention has been described in detail by use of the foregoing embodiments. However, it is apparent to those skilled in the art that the present invention should not be limited to the embodiments described in the specification. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

Note that the entire content of Japanese Patent Application No. 2013-200657 (filed on Sep. 26, 2013) is incorporated herein by reference in the present specification.

### INDUSTRIAL APPLICABILITY

As described above, the present invention can provide the mobile communication system capable of appropriately setting the SRB0 to the SRB2 when the “Inter-eNB CA” is performed.

### EXPLANATION OF THE REFERENCE NUMERALS

UE mobile station

eNB#1 (MeNB), eNB#2 (SeNB) radio base station

1. A mobile communication system configured such that a mobile station is capable of performing carrier aggregation using a cell under a master radio base station and a cell under a slave radio base station, wherein
an SRB0, an SRB1, and an SRB2 are configured to be established between the mobile station and the master radio base station when the carrier aggregation is performed, and
the slave radio base station is configured to send the mobile station a signal for adding or changing SRBs when the slave radio base station is added, to establish an SRB1 and an SRB2 between the mobile station and the slave radio base station with the same setting contents as those of the SRB1 and the SRB2 established between the mobile station and the master radio base station.

2. A mobile communication system configured such that a mobile station is capable of performing carrier aggregation using a cell under a master radio base station and a cell under a slave radio base station, wherein
an SRB0, an SRB1, and an SRB2 are configured to be established between the mobile station and the master radio base station when the carrier aggregation is performed,
the master radio base station is configured to notify the slave radio base station of setting information of the SRB1 and the SRB2 and give an instruction to the mobile station to add the slave radio base station, and
the mobile station is configured to use the setting information of the SRB1 and the SRB2 established between the mobile station and the master radio base station to apply to setting for sending a signal on the SRB1 and the SRB2 via the slave radio base station, in response to the instruction.
